(19) United States
(12) Patent Application Publication
(10) Pub. No.: US 2026/0115982 A1
(43) Pub. Date: Apr. 30, 2026

(54) INJECTION MOLDING MACHINE

(71) Applicants: SUMITOMO HEAVY INDUSTRIES, LTD., Tokyo (JP); SEIKOH GIKEN CO., LTD., Matsudo-shi (JP)

(72) Inventors: Yuta NESAKI, Chiba-shi (JP); Yasuo SUZUKI, Chiba-shi (JP); Masahiro IWAHASHI, Chiba-shi (JP); Norihiro KAKINUMA, Matsudo-shi (JP); Masami SUZUKI, Matsudo-shi (JP); Kenichi TANAKA, Matsudo-shi (JP); Arihito IIDA, Matsudo-shi (JP)

(21) Appl. No.: 19/366,583

(22) Filed: Oct. 23, 2025

(30) Foreign Application Priority Data
Oct. 25, 2024 (JP) 2024-187969

(51) Int. Cl. B29C 45/70; B29C 45/16; B29C 45/47; B29C 45/50; B29C 45/62; B29C 45/76; B29C 45/77; B29C 45/78

(52) U.S. Cl. CPC B29C 45/70; B29C 45/1635; B29C 45/47; B29C 45/50; B29C 45/62; B29C 45/76; B29C 45/77; B29C 45/78; B29C 2945/76006; B29C 2945/7604; B29C 2945/7612; B29C 2945/76187; B29C 2945/76204

(57) ABSTRACT

An injection molding machine includes: a mold clamping unit that moves a movable platen that supports a movable mold to a stationary platen side that supports a stationary mold to apply a first mold clamping force from a movable platen side to the movable mold and the stationary mold; an injection unit that injects a material into a gap between the movable mold and the stationary mold; and a compression unit that applies a second mold clamping force from the stationary platen side to the movable mold and the stationary mold.

### CROSS-REFERENCE TO RELATED APPLICATIONS

This application claims priority to Japanese Patent Application No. 2024-187969, filed on Oct. 25, 2024, which is incorporated by reference herein in its entirety.

### BACKGROUND

### Technical Field

A certain embodiment of the present invention relates to an injection molding machine.

### Description of Related Art

A display unit of an injection molding machine is described in the related art. The display unit displays a setting screen for setting control of a torque of an ejector motor by a control device, based on a mold internal pressure in a cavity space of a mold unit that represents a force against the drive of the ejector motor.

### SUMMARY

According to an embodiment of the present invention, there is provided an injection molding machine including: a mold clamping unit that moves a movable platen that supports a movable mold to a stationary platen side that supports a stationary mold to apply a first mold clamping force from a movable platen side to the movable mold and the stationary mold; an injection unit that injects a material into a gap between the movable mold and the stationary mold; and a compression unit that applies a second mold clamping force from the stationary platen side to the movable mold and the stationary mold.

### BRIEF DESCRIPTION OF THE DRAWINGS

FIG. 1 is a view illustrating a configuration of an injection molding machine according to the present embodiment.

FIG. 2 is a view illustrating the configuration of the injection molding machine according to the present embodiment.

FIG. 3 is a perspective view illustrating a main part of the injection molding machine according to the present embodiment.

FIG. 4 is a perspective view illustrating the main part of the injection molding machine according to the present embodiment.

FIG. 5 is a top view illustrating a mechanism on a counter-operation side of the main part of the injection molding machine according to the present embodiment.

FIG. 6 is a view illustrating a mechanism that prevents a large mold clamping force from being applied from a mold clamping unit to a mold on the counter-operation side.

FIG. 7 is a graph illustrating a transition of the magnitude of the mold clamping force acting on the mold in one cycle of mold opening and closing.

### DETAILED DESCRIPTION

In general, a mold clamping force of a mold is generated by shortening a distance between platens by opening and closing a mold clamping unit. However, in a case where a part of the mold is to be moved, such as core compression, the opening and closing of the mold clamping unit cannot cope with this case.

As a method of applying the mold clamping force to the mold other than using the mold clamping unit, there is a method of applying the mold clamping force by ejector compression. However, since the ejector generally operates on a movable platen side, in this method, the mold clamping force can be applied to the mold only from the movable platen side.

It is desirable to apply the mold clamping force to the mold from a stationary platen side.

The compression unit may be mounted on the injection unit. In that case, the compression unit may apply the second mold clamping force to the movable mold and the stationary mold when the injection unit injects the material into the gap between the movable mold and the stationary mold.

The mold clamping unit may move the movable platen that supports a first movable mold to the stationary platen side that supports a first stationary mold and a second stationary mold to apply the first mold clamping force from the movable platen side to the first movable mold, the first stationary mold, and the second stationary mold, the injection unit may include a first injection unit that injects a first material into a gap between the first movable mold and the first stationary mold, and a second injection unit that injects a second material into a gap between the first movable mold and the second stationary mold after the first material is injected into the gap between the first movable mold and the first stationary mold, and the compression unit may apply the second mold clamping force from the stationary platen side to the first movable mold and the second stationary mold.

In that case, the compression unit may be mounted on the second injection unit. In addition, in that case, the compression unit may apply the second mold clamping force to the first movable mold and the second stationary mold when the second injection unit injects the second material into the gap between the first movable mold and the second stationary mold. In addition, in that case, the compression unit may apply the second mold clamping force to the first movable mold and the second stationary mold when the second injection unit injects the second material from above the first material molded on a surface of the first movable mold. In addition, the mold clamping unit may apply the first mold clamping force of a first magnitude from the movable platen side to the first movable mold and the first stationary mold, and apply the first mold clamping force of a second magnitude smaller than the first magnitude from the movable platen side to the first movable mold and the second stationary mold before the second injection unit injects the second material into the gap between the first movable mold and the second stationary mold, and the compression unit may apply the second mold clamping force smaller than the first magnitude and larger than the second magnitude from the stationary platen side to the first movable mold and the second stationary mold when the second injection unit injects the second material into the gap between the first movable mold and the second stationary mold.

The second injection unit may inject the second material into a central portion of the first movable mold of which a surface is molded with the first material.

Hereinafter, embodiments of the present invention will be described in detail with reference to the accompanying drawings.

### Configuration of Injection Molding Machine

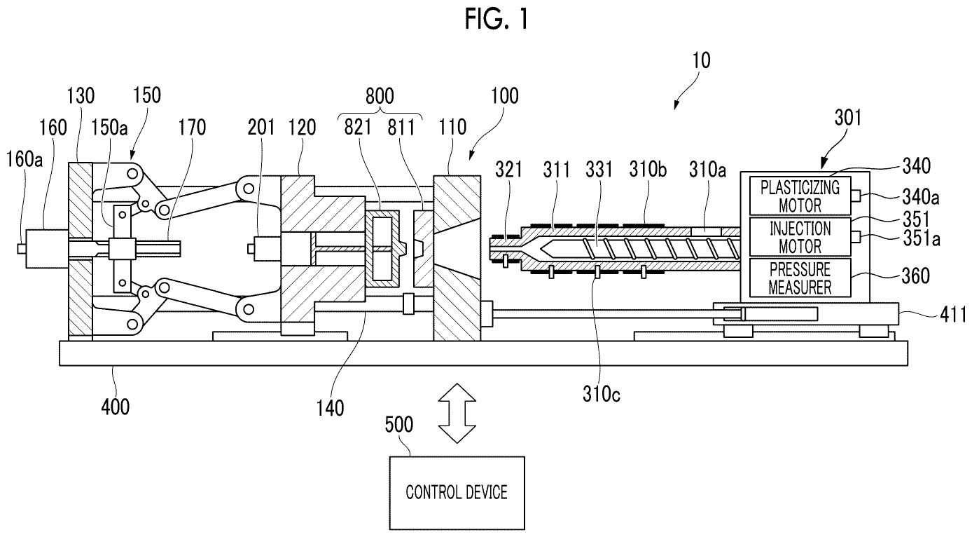

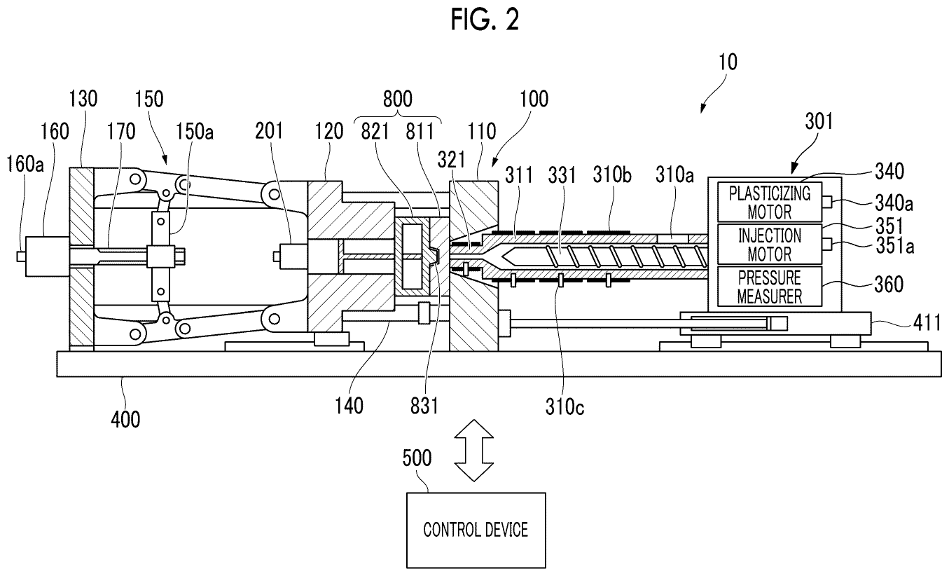

FIGS. 1 and 2 are views illustrating a configuration of an injection molding machine 10 in the present embodiment. FIG. 1 is a view illustrating a state of the injection molding machine 10 at a time of completion of mold opening. FIG. 2 is a view illustrating a state of the injection molding machine 10 at a time of mold clamping. In the injection molding machine 10, a front side in FIGS. 1 and 2 is defined as an operation side, and a rear side in FIGS. 1 and 2 is defined as a counter-operation side. The injection molding machine 10 includes a mold clamping unit 100, a first ejector unit 201, and a second ejector unit 202. Note that the first ejector unit 201 is provided on the operation side, and the second ejector unit 202 is provided on the counter-operation side. Since the positions of the first and second ejector units 201 and 202 in an up-down direction in FIGS. 1 and 2 overlap each other, the second ejector unit 202 is not illustrated in FIGS. 1 and 2. In addition, the injection molding machine 10 includes a first injection unit 301, a second injection unit 302, a frame 400, and a control device 500. Note that the first injection unit 301 is provided on the operation side, and the second injection unit 302 is provided on the counter-operation side. Since the positions of the first and second injection units 301 and 302 in the up-down direction in FIGS. 1 and 2 overlap each other, the second injection unit 302 is not illustrated in FIGS. 1 and 2.

The mold clamping unit 100 performs each of the processes of mold closing, pressure raising, mold clamping, depressurization, and mold opening of a mold 800. In the description of the mold clamping unit 100, a moving direction (rightward direction in FIGS. 1 and 2) of a movable platen 120 at a time of mold closing is defined as a front side, and a moving direction (leftward direction in FIGS. 1 and 2) of the movable platen 120 at a time of mold opening is defined as a rear side.

The mold clamping unit 100 has a stationary platen 110, the movable platen 120, a toggle support 130, a tie bar 140, a toggle mechanism 150, a mold clamping motor 160, and a ball screw 170.

The stationary platen 110 is fixed to the frame 400. A first stationary mold 811 and a second stationary mold 812 are attached to a surface of the stationary platen 110 facing the movable platen 120, as stationary molds configuring the mold 800. Note that the first stationary mold 811 is provided on the operation side, and the second stationary mold 812 is provided on the counter-operation side. Since the positions of the first and second stationary molds 811 and 812 in the up-down direction in FIGS. 1 and 2 overlap each other, the second stationary mold 812 is not illustrated in FIGS. 1 and 2.

The movable platen 120 is provided to be movable with respect to the frame 400 in a mold opening and closing direction (left-right direction in FIGS. 1 and 2). A first movable mold 821 and a second movable mold 822 are attached to a surface of the movable platen 120 facing the stationary platen 110, as movable molds configuring the mold 800. In addition, the movable platen 120 is rotatable about a predetermined rotation axis. The predetermined rotation axis may be an axis perpendicular to the stationary platen 110 and the movable platen 120, and an intermediate axis between a center axis of the first ejector unit 201 and a center axis of the second ejector unit 202. The movable platen 120 rotates about the predetermined rotation axis at a first rotation angle and a second rotation angle. The first rotation angle is a rotation angle at which the first stationary mold 811 and the first movable mold 821 are fitted to each other and the second stationary mold 812 and the second movable mold 822 are fitted to each other. The first rotation angle is, for example, 0°. Meanwhile, the second rotation angle is an angle of rotation at which the first stationary mold 811 and the second movable mold 822 are fitted to each other and the second stationary mold 812 and the first movable mold 821 are fitted to each other. The second rotation angle is, for example, 180°. In FIGS. 1 and 2, a state in which the movable platen 120 is rotated to the first rotation angle is illustrated. In this state, the first movable mold 821 is provided on the operation side, and the second movable mold 822 is provided on the counter-operation side. Since the positions of the first and second movable molds 821 and 822 in the up-down direction in FIGS. 1 and 2 overlap each other, the second movable mold 822 is not illustrated in FIGS. 1 and 2.

The movable platen 120 is advanced and retreated with respect to the stationary platen 110, so that the mold closing, the pressure raising, the mold clamping, the depressurization, and the mold opening of the mold 800 are performed.

The toggle support 130 is provided on the frame 400 to be movable in the mold opening and closing direction at an interval from the stationary platen 110. The tie bar 140 connects the stationary platen 110 and the toggle support 130 to each other in a state where the stationary platen 110 and the toggle support 130 are spaced apart from each other in the mold opening and closing direction.

The toggle mechanism 150 is disposed between the movable platen 120 and the toggle support 130. The toggle mechanism 150 moves the movable platen 120 in the mold opening and closing direction with respect to the toggle support 130 (refer to the toggle mechanism 150 and the movable platen 120 in FIGS. 1 and 2). The toggle mechanism 150 includes a crosshead 150a, a pair of link groups, or the like. The crosshead 150a is a nut for the ball screw 170. As will be described later, when the ball screw 170 rotates around the axis, the crosshead 150a advances and retreats with respect to the toggle support 130. Then, the link group is bent and stretched, and thereby the movable platen 120 advances and retreats with respect to the toggle support 130.

The mold clamping motor 160 and the ball screw 170 are attached to the toggle support 130, and operate the toggle mechanism 150. The ball screw 170 rotates around an axis by receiving the rotation drive of the mold clamping motor 160, and advances and retreats the crosshead 150a, which is a nut, with respect to the toggle support 130. In other words, the ball screw 170 converts a rotary motion of the mold clamping motor 160 into a linear motion of the crosshead 150a. For example, a position or a speed of the crosshead 150a is detected by an encoder 160a of the mold clamping motor 160, or the like. A signal indicating a detection result is sent to the control device 500.

The mold clamping unit 100 performs a mold closing process, a pressure raising process, a mold clamping process, a depressurizing process, a mold opening process, and the like under the control of the control device 500.

In the mold closing process, the mold clamping unit 100 drives the mold clamping motor 160 to rotate the ball screw 170, and advances the crosshead 150a to the mold closing completion position at a set movement speed. Accordingly, the movable platen 120 is advanced, the first movable mold 821 comes into contact with the first stationary mold 811, and the second movable mold 822 comes into contact with the second stationary mold 812.

In a state where the movable platen 120 is rotated to the second rotation angle, the second movable mold 822 comes into contact with the first stationary mold 811, and the first movable mold 821 comes into contact with the second stationary mold 812.

In the pressure raising process, the mold clamping unit 100 further drives the mold clamping motor 160 to further advance the crosshead 150a from a mold closing completion position to a mold clamping position. Accordingly, a mold clamping force (first mold clamping force) is generated in the mold 800.

In the mold clamping process, the mold clamping unit 100 drives the mold clamping motor 160 to maintain the position of the crosshead 150a at the mold clamping position. Accordingly, in the mold clamping process, the mold clamping force generated in the pressure raising process is maintained. In addition, in the mold clamping process, a first cavity space (first gap) 831 is formed between the first movable mold 821 and the first stationary mold 811. The first injection unit 301 fills the first cavity space 831 with a liquid first molding material. The filled first molding material is solidified, and thus a first molding product is obtained. Meanwhile, a second cavity space (second gap) 832 (not illustrated) is formed between the first molding product molded in the second movable mold 822 and the second stationary mold 812. The second injection unit 302 fills the second cavity space 832 with a liquid second molding material. The filled second molding material is solidified, and thus the second molding product including the first molding product is obtained.

In a state where the movable platen 120 is rotated to the second rotation angle, a cavity space (gap) is formed between the second movable mold 822 and the first stationary mold 811. The first injection unit 301 fills the cavity space with the liquid first molding material. The filled first molding material is solidified, and thus the first molding product is obtained. Meanwhile, a cavity space (gap) is formed between the first molding product molded in the first movable mold 821 and the second stationary mold 812. The second injection unit 302 fills the cavity space with the liquid second molding material. The filled second molding material is solidified, and thus the second molding product including the first molding product is obtained.

In the depressurizing process, the mold clamping unit 100 drives the mold clamping motor 160 to rotate the ball screw 170 in a direction opposite to that in the mold closing process and the pressure raising process, and retreats the crosshead 150a from the mold clamping position to a mold opening start position. Accordingly, the movable platen 120 retreats, and the mold clamping force decreases. The mold opening start position may be the same position as the mold closing completion position described in the mold closing process and the pressure raising process.

In the mold opening process, the mold clamping unit 100 drives the mold clamping motor 160 to retreat the crosshead 150a from the mold opening start position to the mold opening completion position at a set movement speed. Accordingly, the movable platen 120 is retreated, and the first movable mold 821 is separated from the first stationary mold 811, and the second movable mold 822 is separated from the second stationary mold 812.

In a state where the movable platen 120 is rotated to the second rotation angle, the second movable mold 822 is separated from the first stationary mold 811, and the first movable mold 821 is separated from the second stationary mold 812.

The first ejector unit 201 performs an ejection process under the control of the control device 500. The second ejector unit 202 also has the same configuration as that of the first ejector unit 201, and performs the ejection process under the control of the control device 500. The first ejector unit 201 and the second ejector unit 202 are attached to the movable platen 120, and are advanced and retreated together with the movable platen 120. In the ejection process, the first ejector unit 201 operates a movable member provided in the first movable mold 821 to eject and remove an unnecessary product from the first movable mold 821. Then, the second ejector unit 202 operates a movable member provided in the second movable mold 822 to eject and remove an unnecessary product and the second molding product from the second movable mold 822.

In a state where the movable platen 120 is rotated to the second rotation angle, the first ejector unit 201 operates the movable member provided in the second movable mold 822 to eject and remove the unnecessary product from the second movable mold 822. Then, the second ejector unit 202 operates a movable member provided in the first movable mold 821 to eject and remove the unnecessary product and the second molding product from the first movable mold 821.

The first injection unit 301 is installed on a slide base 411 that is capable of advancing and retreating with respect to the frame 400, and is capable of advancing and retreating with respect to the mold 800. The first injection unit 301 is brought into contact with the mold 800 and fills the mold 800 with the first molding material. In the description of the first injection unit 301, unlike in the description of the mold clamping unit 100, a movement direction of the screw 331 during filling (left direction in FIGS. 1 and 2) is defined as the front, and a movement direction of the screw 331 during plasticizing (right direction in FIGS. 1 and 2) is defined as the rear.

For example, the first injection unit 301 includes a cylinder 311, a nozzle 321, the screw 331, a plasticizing motor 340, an injection motor 351, a pressure measurer 360, or the like.

The cylinder 311 heats the first molding material fed from a feed port 310a into the cylinder 311. The feed port 310a is formed in a rear portion of the cylinder 311. A heating source 310b such as a heater and a temperature measurer 310c are provided on an outer periphery of the cylinder 311.

The cylinder 311 is divided into a plurality of zones in an axial direction (right-left direction in FIGS. 1 and 2) of the cylinder 311. The heating source 310b and the temperature measurer 310c are provided in each zone. The control device 500 controls the heating source 310b such that an actual measured temperature of the temperature measurer 310c reaches a set temperature for each zone.

The nozzle 321 is provided at a front end portion of the cylinder 311 and is pressed against the mold 800. The heating source 310b such as a heater and the temperature measurer 310c are provided on an outer periphery of the nozzle 321. The control device 500 controls the heating source 310b such that an actual measured temperature of the nozzle 321 reaches the set temperature.

The screw 331 is disposed in the cylinder 311 to be rotatable and to be capable of advancing and retreating.

The plasticizing motor 340 sends the first molding material to the front side along a helical groove of the screw 331 by rotating the screw 331. The first molding material is gradually melted by heat from the cylinder 311 while being fed forward. The liquid first molding material is fed to a front side of the screw 331 and is accumulated in a front portion of the cylinder 311, and thus the screw 331 is retreated.

The injection motor 351 advances and retreats the screw 331. The injection motor 351 injects the liquid first molding material accumulated in front of the screw 331 from the cylinder 311 and fills the mold 800 with the liquid first molding material by advancing the screw 331. Thereafter, the injection motor 351 pushes the screw 331 forward, and applies a pressure to the first molding material in the mold 800. Accordingly, the first molding material of which the amount is insufficient is replenished. A motion conversion mechanism that converts a rotary motion of the injection motor 351 into a linear motion of the screw 331 is provided between the injection motor 351 and the screw 331. The motion conversion mechanism is configured by, for example, a ball screw mechanism.

For example, the pressure measurer 360 is disposed between the injection motor 351 and the screw 331, and measures a pressure received by the screw 331 from the first molding material, a back pressure with respect to the screw 331, or the like. The pressure received by the screw 331 from the first molding material corresponds to the pressure acting on the first molding material from the screw 331. The pressure measurer 360 sends a signal indicating a measurement result to the control device 500.

The first injection unit 301 performs a filling process, a pressure holding process, a plasticizing process, and or the like under the control of the control device 500.

In the filling process, the first injection unit 301 drives the injection motor 351 to advance the screw 331 at a set speed, and fills the mold 800 with the liquid first molding material accumulated in front of the screw 331. For example, a position or a speed of the screw 331 is detected by an encoder 351a of the injection motor 351. A signal indicating the detection result is sent to the control device 500. When the position of the screw 331 reaches a predetermined position, switching (so called V/P switching) from the filling process to the pressure holding process is performed. A set speed of the screw 331 may be changed according to the position of the screw 331, a time, or the like.

In the pressure holding process, the first injection unit 301 drives the injection motor 351 to press the screw 331 forward at a setting pressure and apply a pressure to the first molding material in the mold 800. Accordingly, the first molding material of which the amount is insufficient is replenished. For example, the pressure of the first molding material is measured by the pressure measurer 360. A signal indicating the detection result is sent to the control device 500.

In the pressure holding process, the first molding material in the mold 800 is gradually cooled, and at a time of completion of the pressure holding process, an inlet of the first cavity space 831 is closed with the solidified first molding material. This state is referred to as a gate seal, and a backflow of the first molding material from the first cavity space 831 is prevented. After the pressure holding process, a cooling process starts. In the cooling process, solidification of the first molding material in the first cavity space 831 is performed. In order to shorten a molding cycle, the plasticizing process may be performed during the cooling process.

In the plasticizing process, the first injection unit 301 drives the plasticizing motor 340 to rotate the screw 331 at a set rotation speed, and feeds the first molding material forward along a helical groove of the screw 331. Accordingly, the first molding material is gradually melted. The liquid first molding material is fed to the front side of the screw 331 and is accumulated in the front portion of the cylinder 311, and thus the screw 331 is retreated. For example, the rotation speed of the screw 331 is measured by an encoder 340a of the plasticizing motor 340. A signal indicating the detection result is sent to the control device 500.

In the plasticizing process, the first injection unit 301 may drive the injection motor 351 to apply a set back pressure to the screw 331 to limit the sudden retreat of the screw 331. For example, the back pressure with respect to the screw 331 is measured by the pressure measurer 360. A signal indicating the detection result is sent to the control device 500. When the screw 331 is retreated to a predetermined position and a predetermined amount of the first molding material is accumulated in front of the screw 331, the plasticizing process ends.

The second injection unit 302 is installed on a slide base 412 (not illustrated) which is capable of advancing and retreating with respect to the frame 400, and is capable of advancing and retreating with respect to the mold 800. The second injection unit 302 applies a mold clamping force to the mold 800 in addition to filling the mold 800 with the second molding material. The configuration of the second injection unit 302 will be described later.

### Configuration of Present Embodiment

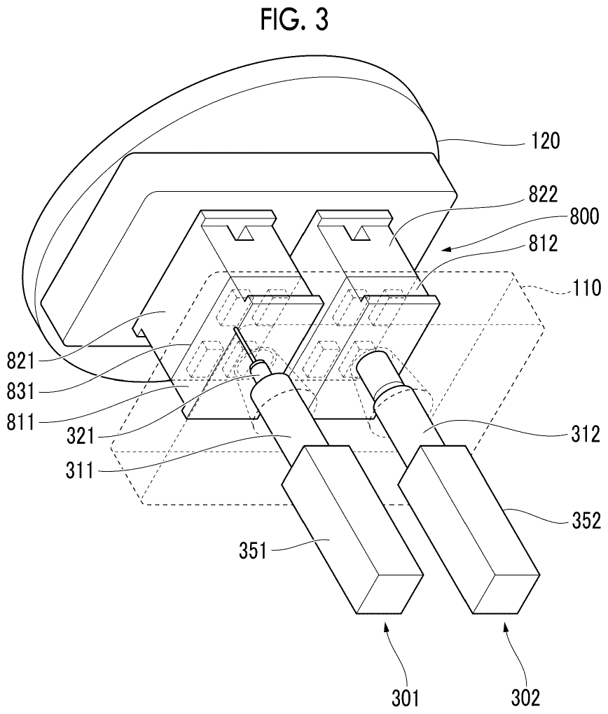

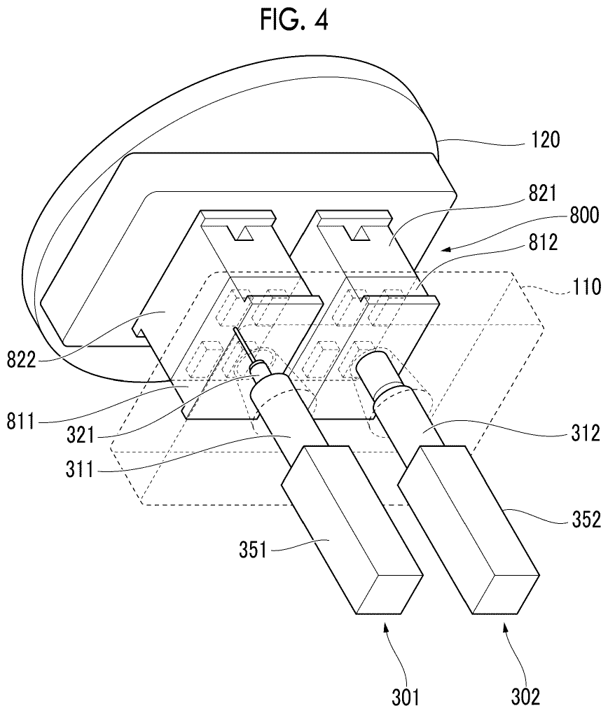

FIGS. 3 and 4 are perspective views illustrating a main part of the injection molding machine 10 illustrated in FIGS. 1 and 2. In FIGS. 3 and 4, the left side corresponds to the operation side, and the right side corresponds to the counter-operation side. The main part of the injection molding machine 10 illustrated in FIGS. 3 and 4 includes the stationary platen 110, the movable platen 120, the first movable mold 821, and the second movable mold 822. In addition, the main part of the injection molding machine 10 includes the first injection unit 301 and the first stationary mold 811 on the operation side. Further, the main part of the injection molding machine 10 includes the second injection unit 302 and the second stationary mold 812 on the counter-operation side. The first injection unit 301 injects the liquid first molding material (for example, a resin of a first color). The second injection unit 302 applies an additional mold clamping force (second mold clamping force) to the mold 800. In addition, the second injection unit 302 injects a liquid second molding material (for example, a resin of a second color).

First, as illustrated in FIG. 3, it is assumed that the movable platen 120 is rotated to the first rotation angle. That is, the first stationary mold 811 and the first movable mold 821 face each other on the operation side, and the second stationary mold 812 and the second movable mold 822 face each other on the counter-operation side. In this case, the first injection unit 301 injects the first molding material into the first cavity space 831 between the first stationary mold 811 and the first movable mold 821. Specifically, the injection motor 351 injects the first molding material from the nozzle 321 by pressing the screw 331 (not illustrated) in the cylinder 311 forward.

Thereafter, as illustrated in FIG. 4, it is assumed that the movable platen 120 is rotated to the second rotation angle. That is, the first stationary mold 811 and the second movable mold 822 face each other on the operation side, and the second stationary mold 812 and the first movable mold 821 face each other on the counter-operation side. In this case, the second injection unit 302 applies additional mold clamping forces to the second stationary mold 812 and the first movable mold 821. Specifically, the injection motor 352 applies the additional mold clamping force by pressing the compression unit 312 forward. In addition, the second injection unit 302 injects the second molding material into the cavity space between the second stationary mold 812 and the first movable mold 821. Specifically, the compression unit 312 injects the second molding material from a tip thereof.

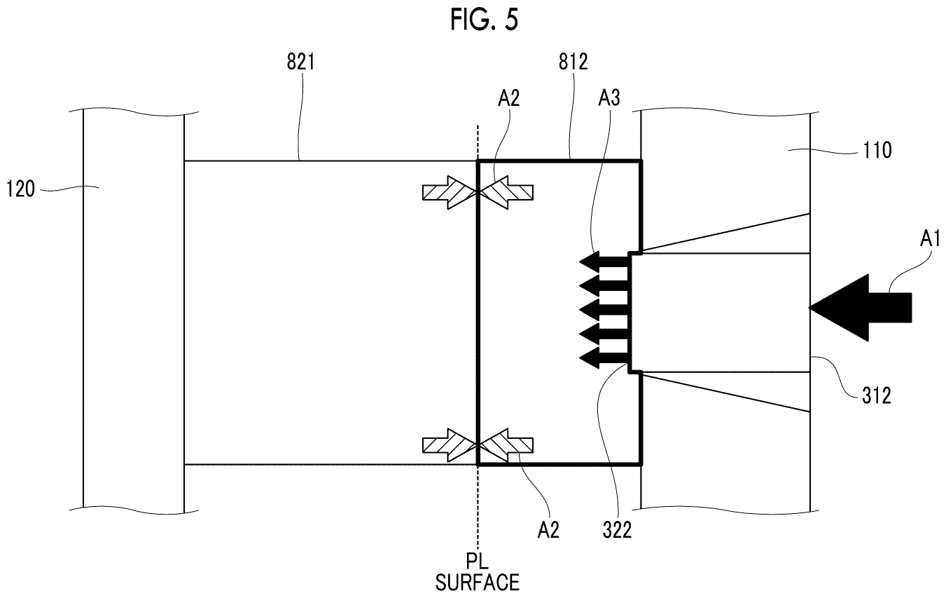

FIG. 5 is a top view illustrating a mechanism on the counter-operation side of the main part of the injection molding machine 10 in a state illustrated in FIG. 4. The mechanism on the counter-operation side of the main part of the injection molding machine 10 includes the stationary platen 110, the movable platen 120, the second stationary mold 812, the first movable mold 821, and the compression unit 312. As illustrated, the compression unit 312 is pressed as indicated by an arrow A1 to apply an additional mold clamping force to the second stationary mold 812. Accordingly, the additional mold clamping force is applied to a PL surface between the second stationary mold 812 and the first movable mold 821 as indicated by an arrow A2. At that time, the compression unit 312 injects the second molding material from a plurality of injection ports 322 provided in the tip thereof as indicated by an arrow A3.

In other words, the compression unit 312 applies the additional mold clamping force when the second molding material is injected into the cavity space between the first movable mold 821 and the second stationary mold 812. Furthermore, the compression unit 312 applies the additional mold clamping force when the second molding material is injected from above the first molding material molded on a surface of the first movable mold 821 by the second injection unit 302. Here, it is assumed that the second molding material fills a surface side (second injection unit 302 side) and a side surface of the first molding material and does not fill a back surface side (opposite side to the second injection unit 302) of the first molding material. Under this premise, the “from above” means from the second injection unit 302 side (the side where the filled first molding material exists).

A case where a viscosity of the second molding material is extremely low, for example, a viscosity of 8000 mPa's or less, is considered as compared to the first molding material. In this case, it is necessary to reduce the mold clamping force applied to the second molding material in the state illustrated in FIG. 4 more than the mold clamping force applied to the first molding material in the state illustrated in FIG. 3. Otherwise, there is a possibility that air is not completely removed when the second molding material is injected into the cavity space between the second stationary mold 812 and the first movable mold 821, which may cause a shot or the like. For this reason, a mechanism that receives the mold clamping force is provided on the side into which the second molding material is to be injected. In this manner, it is assumed that the force from the mold clamping unit 100 is hardly applied to the cavity space between the second stationary mold 812 and the first movable mold 821. Thereafter, the second injection unit 302 applies the additional mold clamping force when the second molding material is injected into the cavity space between the second stationary mold 812 and the first movable mold 821. In this case, the additional mold clamping force should be a value smaller than the mold clamping force from the mold clamping unit 100. This is because there is a possibility that the second stationary mold 812 or the first movable mold 821 is damaged in a case where the additional mold clamping force is larger than the mold clamping force from the mold clamping unit 100. Therefore, in the present embodiment, the second injection unit 302 applies the additional mold clamping force smaller than the mold clamping force from the mold clamping unit 100. Accordingly, the mold clamping force applied to the mold 800 filled with the second molding material can be reduced as compared to the mold clamping force applied to the mold 800 filled with the first molding material, and it is possible to avoid defects such as a shot caused by an excessive mold clamping force. In such a case, it is necessary to prepare a mechanism for preventing a large mold clamping force from being applied to the mold 800 on the counter-operation side from the mold clamping unit 100 in the mold 800 or the injection molding machine 10.

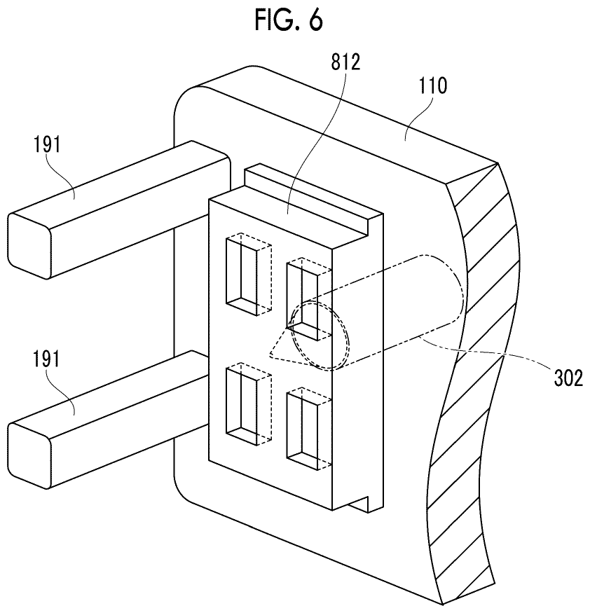

FIG. 6 is a view illustrating such a mechanism. Although not illustrated in FIGS. 3 and 4, a pair (two) of pillars 191 are provided on a facing surface of the stationary platen 110 facing the movable platen 120. Each of the pillars 191 extends linearly from the stationary platen 110 toward the movable platen 120 and has a set length. The number of the pillars 191 is not particularly limited, and may be one or may be three or more. The pair of pillars 191 are installed at adjacent positions on the counter-operation side of the second stationary mold 812.

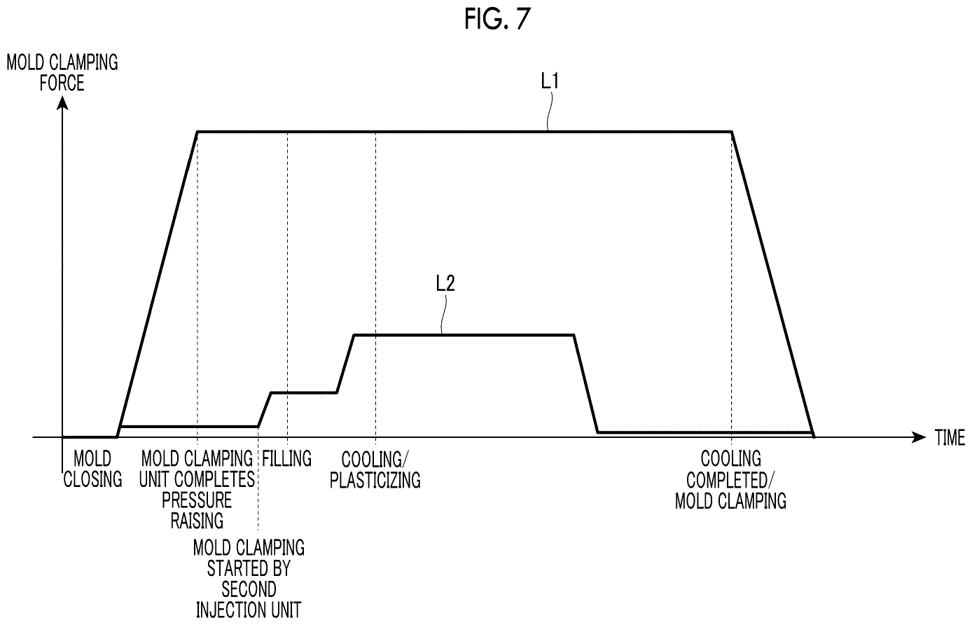

FIG. 7 is a graph illustrating a transition of the magnitude of the mold clamping force applied to the mold 800 in one cycle of the mold opening and closing. Here, a case where the movable platen 120 is rotated to the first rotation angle as illustrated in FIG. 3 will be described as an example.

A broken line L1 illustrates a transition of the magnitude of the mold clamping force received by the first stationary mold 811 and the first movable mold 821. In this case, as illustrated by the broken line L1, the first stationary mold 811 and the first movable mold 821 receive a large mold clamping force from the mold clamping unit 100. Here, the mold clamping forces received by the first stationary mold 811 and the first movable mold 821 from the mold clamping unit 100 are examples of the mold clamping forces of a first magnitude.

A broken line L2 illustrates a transition of the magnitude of the mold clamping force received by the second stationary mold 812 and the second movable mold 822. In this case, before the mold clamping is started by the second injection unit 302, the second stationary mold 812 and the second movable mold 822 receive almost no mold clamping force from the mold clamping unit 100 by the mechanism illustrated in FIG. 6. Here, the mold clamping forces received by the second stationary mold 812 and the second movable mold 822 from the mold clamping unit 100 are examples of a second magnitude of the mold clamping forces smaller than the first magnitude. Then, after the mold clamping is started by the second injection unit 302, the second stationary mold 812 and the second movable mold 822 receive the additional mold clamping force from the second injection unit 302. The additional mold clamping force is smaller than the mold clamping force from the mold clamping unit 100. Here, the additional mold clamping forces received by the second stationary mold 812 and the second movable mold 822 from the second injection unit 302 are examples of the mold clamping forces smaller than the first magnitude and larger than the second magnitude.

Here, as illustrated by the broken line L2, the mold clamping force applied during filling is increased during cooling and metering. This is because a problem occurs in that air cannot be exhausted when a large mold clamping force is applied from the beginning. In addition, when the cooling is continued with a small mold clamping force, the mold clamping force is not sufficiently transmitted to the molding product.

In addition, in the present embodiment, the compression unit 312 may be assembled as part of the second injection unit 302. That is, the second injection unit 302 may be configured by replacing the assembly of the screw 331 of the first injection unit 301 with the assembly of the compression unit 312.

In this manner, the additional mold clamping force can be generated by pressing the compression unit 312 against the mold 800 without changing the performance of the injection unit for normal molding.

In addition, the assembly of the compression unit 312 may be replaced with the assembly of the screw 331. In this manner, it is also easy to return to the normal molding.

Further, a high mold clamping force that cannot be obtained by a nozzle touch force or an ejector protrusion of a normal injection unit can be applied. In a case of trying to generate a high mold clamping force with a nozzle touch force, it is necessary to make a modification such as increasing the size of the hydraulic cylinder or increasing the number of hydraulic cylinders, but in the case of replacing the assembly, such modification is not required.

### SUMMARY OF PRESENT EMBODIMENT

In the present embodiment, the mold 800 into which the second molding material is injected is subjected to the additional mold clamping force from the stationary platen 110 side. When the additional mold clamping force is applied from the movable platen 120 side, the first molding material is interposed, and thus the additional mold clamping force cannot be properly transmitted. In contrast, in the present embodiment, the contact pressure can be directly applied to the injected second molding material. Therefore, the present embodiment is effective in a two-material molding machine or an insert molding machine.

In addition, in the present embodiment, the mold 800 is filled with the molding material by applying the additional mold clamping force to the mold 800 from the stationary platen 110 side. In this manner, unlike the method of injecting the mold 800 from the side surface or the top and bottom surface, the molding material can be filled from the center of the mold 800. When the filling of the molding material can be performed from the center of the mold 800 in this way, uniform filling of the molding material can be realized in the product. Here, a case will be considered in which the additional mold clamping force is applied to the mold 800 from the movable platen 120 side to fill the mold with the molding material. In this case, since the ejector unit is provided on the movable platen 120 side, it is impossible to perform the filling of the molding material from the center of the mold 800. Further, in the present embodiment, the additional mold clamping force is applied from the compression unit of the injection unit. Accordingly, it is possible to apply the additional mold clamping force from the stationary platen 110 side without using an additional drive source such as an external actuator.

Further, in the present embodiment, it is also possible to apply an optional additional mold clamping force to the mold 800 from the stationary platen 110 side by controlling the operation of the compression unit.

### MODIFICATION EXAMPLES

In the above, it is assumed that the compression unit 312 is mounted on the second injection unit 302. According to such a configuration, it is not necessary to prepare an external unit in order to apply the additional mold clamping force from the stationary platen 110 side, and there is no need to incur additional operating costs. However, the present invention is not limited to such a configuration. The compression unit 312 may be provided separately from the second injection unit 302.

In addition, in the above description, the present embodiment is applied to a so-called two-material molding machine in which the first injection unit 301 injects the first molding material and then the second injection unit 302 injects the second molding material. However, the present embodiment may be applied to a so-called single material molding machine in which a single injection unit injects a single molding material. In that case, the present embodiment can be regarded as a configuration in which the compression unit for pressing the mold 800 is mounted on the injection unit, separately from the mold clamping unit 100 of the injection molding machine 10. In addition, the present embodiment can be regarded as a configuration in which the compression unit moves to the mold 800 side when the injection unit performs the injection operation, and presses the mold 800 from the stationary platen 110 side. Here as well, the compression unit is mounted on the injection unit. However, the present invention is not limited to such a configuration. The compression unit may be provided separately from the injection unit.

In addition, in the above description, the second injection unit 302 is used as the injection unit in the injection molding machine 10. However, the present invention is not limited thereto. The second injection unit 302 may be a device that is made of only a plunger or a piston for extruding a highly viscous material and that does not have the plasticizing motor or the injection motor.

It should be understood that the invention is not limited to the above-described embodiment, but may be modified into various forms on the basis of the spirit of the invention. Additionally, the modifications are included in the scope of the invention.

What is claimed is:

1. An injection molding machine comprising:
a mold clamping unit that moves a movable platen that supports a movable mold to a stationary platen side that supports a stationary mold to apply a first mold clamping force from a movable platen side to the movable mold and the stationary mold;
an injection unit that injects a material into a gap between the movable mold and the stationary mold; and
a compression unit that applies a second mold clamping force from the stationary platen side to the movable mold and the stationary mold.

2. The injection molding machine according to claim 1,
wherein the compression unit is mounted on the injection unit.

3. The injection molding machine according to claim 2,
wherein the compression unit applies the second mold clamping force to the movable mold and the stationary mold when the injection unit injects the material into the gap between the movable mold and the stationary mold.

4. The injection molding machine according to claim 1,
wherein the mold clamping unit moves the movable platen that supports a first movable mold to the stationary platen side that supports a first stationary mold and a second stationary mold to apply the first mold clamping force from the movable platen side to the first movable mold, the first stationary mold, and the second stationary mold,
the injection unit includes a first injection unit that injects a first material into a gap between the first movable mold and the first stationary mold, and a second injection unit that injects a second material into a gap between the first movable mold and the second stationary mold after the first material is injected into the gap between the first movable mold and the first stationary mold, and
the compression unit applies the second mold clamping force from the stationary platen side to the first movable mold and the second stationary mold.

5. The injection molding machine according to claim 4,
wherein the first injection unit includes a cylinder that heats the first material fed from a feed port into the cylinder, a nozzle provided at a front end portion of the cylinder, a screw disposed in the cylinder to be rotatable and to advance and retreat, a plasticizing motor that rotates the screw, an injection motor that advances and retreats the screw, and a pressure measurer.

6. The injection molding machine according to claim 5,
wherein the feed port is formed in a rear portion of the cylinder, and a heating source and a temperature measurer are provided on an outer periphery of the cylinder.

7. The injection molding machine according to claim 5,
wherein the plasticizing motor includes an encoder that measures a rotation speed of the screw.

8. The injection molding machine according to claim 5,
wherein the pressure measurer is disposed between the injection motor and the screw, and measures a pressure received by the screw from the first material and a back pressure with respect to the screw.

9. The injection molding machine according to claim 4,
wherein the compression unit is mounted on the second injection unit.

10. The injection molding machine according to claim 9,
wherein the compression unit applies the second mold clamping force to the first movable mold and the second stationary mold when the second injection unit injects the second material into the gap between the first movable mold and the second stationary mold.

11. The injection molding machine according to claim 10,
wherein the compression unit applies the second mold clamping force to the first movable mold and the second stationary mold when the second injection unit injects the second material from above the first material molded on a surface of the first movable mold.

12. The injection molding machine according to claim 10,
wherein the mold clamping unit applies the first mold clamping force of a first magnitude from the movable platen side to the first movable mold and the first stationary mold, and applies the first mold clamping force of a second magnitude smaller than the first magnitude from the movable platen side to the first movable mold and the second stationary mold before the second injection unit injects the second material into the gap between the first movable mold and the second stationary mold, and
the compression unit applies the second mold clamping force smaller than the first magnitude and larger than the second magnitude from the stationary platen side to the first movable mold and the second stationary mold when the second injection unit injects the second material into the gap between the first movable mold and the second stationary mold.

13. The injection molding machine according to claim 9,
wherein the second injection unit injects the second material into a central portion of the first movable mold of which a surface is molded with the first material.
